(19) United States
(12) Patent Application Publication
(10) Pub. No.: US 2020/0410347 A1
(43) Pub. Date: Dec. 31, 2020

(54) METHOD AND DEVICE FOR ASCERTAINING A NETWORK CONFIGURATION OF A NEURAL NETWORK

(71) Applicants: Robert Bosch GmbH, Stuttgart (DE); Albert-Ludwigs-Universitaet Freiburg, Freiburg (DE)

(72) Inventors: Thomas Elsken, Sindelfingen (DE); Frank Hutter, Freiburg (DE); Jan Hendrik Metzen, Boeblingen (DE)

(21) Appl. No.: 16/978,075

(22) PCT Filed: Apr. 17, 2019
(86) PCT No.: PCT/EP2019/059992

§ 371 Date: Sep. 3, 2020

(30) Foreign Application Priority Data
Apr. 24, 2018 (DE) 10 2018 109 851.0

(51) Int. Cl. G06N 3/08; G06N 3/04

(52) U.S. Cl. CPC G06N 3/08; G06N 3/04

(57) ABSTRACT

A method for ascertaining a suitable network configuration for a neural network for a predefined application that is determined in the form of training data. The method includes: a) starting from an instantaneous network configuration, generating multiple network configurations which differ in a portion of the instantaneous network configuration by applying approximate network morphisms; b) ascertaining affected network portions of the network configurations; c) multiphase training of each of the network configurations to be evaluated, under predetermined training conditions, in a first phase, in each case network parameters of a portion that is not changed by applying the particular approximate network morphism remaining unconsidered during the training, and all network parameters being trained in at least one further phase, d) determining a resulting prediction error for each of the network configurations to be evaluated; e) selecting the suitable network configuration as a function of the determined prediction errors.

### FIELD

The present invention relates to neural networks, in particular for implementing functions of a technical system, in particular a robot, a vehicle, a tool, or a work machine. Moreover, the present invention relates to the architecture search of neural networks in order to find for a certain application a configuration of a neural network that is optimized with regard to one or multiple parameters.

### BACKGROUND INFORMATION

The performance of neural networks is determined primarily by their architecture. The architecture of a neural network is specified, for example, by its network configuration, which is specified by the number of neuron layers, the type of neuron layers (linear transformations, nonlinear transformations, normalization, linkage with further neuron layers, etc.), and the like. In particular with increasing complexity of the applications and of the tasks to be performed, randomly finding suitable network configurations is laborious, since each candidate of a network configuration must initially be trained to allow its performance to be evaluated.

To improve the search for a suitable network configuration, expert knowledge is generally applied in order to reduce the number of candidates for possible network configurations prior to their training. In this way, a search may be made in a subset of meaningful network architectures.

Despite this approach, the set of possible network configurations is immense. Since an assessment of a network configuration is determined only after a training, for example by evaluating an error value, for complex tasks and correspondingly complex network configurations this results in significant search times for a suitable network configuration.

A method for the architecture search of neural networks is described in T. Elsken et al., “Simple and efficient architecture search for convolutional neural networks,” ICLR, www.arxiv.net/abs/1711.04528, which evaluates network configuration variants with respect to their performance with the aid of a hill climbing strategy, those network configuration variants whose performance is maximal being selected, and network morphisms being applied to the selected configuration variants in order to generate network configuration variants to be newly evaluated. A model training using fixed training parameters is carried out for evaluating the performance of the configuration variant. The use of network morphisms significantly reduces the necessary computing capacity by reusing the information from the training of the instantaneous configuration variant for configuration variants to be newly evaluated.

### SUMMARY

According to the present invention, a method for determining a network configuration for a neural network, based on training data for a given application, and a corresponding, are provided.

Example embodiments of the present invention are described herein.

According to a first aspect of the present invention, a method for ascertaining a suitable network configuration for a neural network for a predefined application, in particular for implementing functions of a technical system, in particular a robot, a vehicle, a tool, or a work machine, is provided. In accordance with an example embodiment of the present invention, it may be provided that the application is determined in the form of training data, the network configuration indicating the architecture of the neural network, including the following steps:
a) starting from an instantaneous network configuration, by applying approximate network morphisms, multiple network configurations to be evaluated are generated which differ in a portion of the instantaneous network configuration;
b) ascertaining affected network portions of the network configurations;
c) multiphase training of each of the network configurations to be evaluated, under predetermined training conditions, in a first training phase, in each case network parameters of a portion that is not changed by applying the particular approximate network morphism remaining unconsidered during the training, and all network parameters being trained in at least one further training phase;
d) determining a prediction error for each of the network configurations; and
e) selecting the suitable network configuration as a function of the determined prediction errors.

In accordance with the example method of the present invention, starting from a starting network configuration of a neural network, network configuration variants are generated by applying approximate network morphisms, and a prediction error is ascertained for them. The configuration variants are assessed according to the prediction error, and one or multiple of the network configurations are selected as a function of the prediction error in order to optionally generate therefrom new network configuration variants by reapplying approximate network morphisms.

In particular for complex applications/tasks, complex network configurations with a large number of neurons are required, so that it has thus far been necessary to train a large set of network parameters during the training operation. A comprehensive training for ascertaining the prediction error is therefore complicated. In this regard, it is provided to reduce the evaluation effort by determining the prediction error after a multiphase training of the neural networks indicated by the network configuration. This allows an assessment and a comparability of the prediction errors with greatly reduced computing time.

According to the example method of the present invention, for reducing the evaluation effort for each of the network configurations to be evaluated, for determining the prediction error in a first training phase network parameter, it is provided to further train only those network portions of the neural network that have been varied by applying the network morphism. The network portions of the neural network not affected by the network morphism are thus not considered during the training; i.e., the network parameters of the network portions of the neural network not affected by the network morphism are taken over for the varied network configuration to be evaluated, and fixed during the training, i.e., left unchanged. Thus, only the portions of the neural network affected by the variation are trained. Portions of a network that are affected by a variation of a network morphism are all added and modified neurons, and all neurons which on the input side or on the output side are connected to at least one added, modified, or removed neuron.

In a further training phase, the neural network of the network configuration to be evaluated is subsequently further trained, starting from the training result of the first training phase corresponding to shared further training conditions.

The example method may have the advantage that due to the multiphase training, a meaningful and comparable prediction error is possible that is achieved more quickly than would be the case for a single-phase conventional training without accepting network parameters. On the one hand, such a training may be carried out much more quickly and with much lower resource consumption, and the architecture search may thus be carried out more quickly overall. On the other hand, the method is adequate to evaluate whether an improvement in the performance of the neural network in question may be achieved by modifying the neural network.

In addition, steps a) through e) may be carried out iteratively multiple times by using a network configuration which is found in each case as an instantaneous network configuration for generating multiple network configurations to be evaluated. The method is thus iteratively continued, with only network configuration variants of the neural networks being refined for which the prediction error indicates an improvement in the performance of the network configuration to be assessed.

In particular, the example method may be ended when an abort condition is met, the abort condition involving the occurrence of at least one of the following events:
a predetermined number of iterations has been reached,
a predetermined prediction error value has been reached by at least one of the network configuration variants.

In addition, the approximate network morphisms may in each case provide a change in a network configuration for an instantaneous training state in which the prediction error initially increases, but after the first training phase does not change by more than a predefined maximum error amount.

It may be provided that the approximate network morphisms for conventional neural networks in each case provide for the removal, addition, and/or modification of one or multiple neurons or one or multiple neuron layers.

Furthermore, the approximate network morphisms for convolutional (folding) neural networks may in each case provide for the removal, addition, and/or modification of one or multiple layers, the layers including one or multiple convolution layers, one or multiple normalization layers, one or multiple activation layers, and one or multiple fusion layers.

According to one specific embodiment of the present invention, the training data may be predefined by input parameter vectors and output parameter vectors associated with same, the prediction error of the particular network configuration after the further training phase being determined as a measure that results from the particular deviations between model values that result from the neural network, determined by the particular network configuration, based on the input parameter vectors, and from the output parameter vectors associated with the input parameter vectors. The prediction error may thus be ascertained by comparing the training data to the feedforward computation results of the neural network in question. The prediction error may in particular be ascertained based on a training under predetermined conditions, for example using in each case the identical training data for a predetermined number of training passes.

In addition, the shared predetermined first training conditions for training each of the network configurations in the first training phase may specify a number of training passes and/or a training time and/or a training method, and/or the shared predetermined second training conditions for training each of the network configurations in the second training phase may specify a number of training passes and/or a training time and/or a training method.

According to a further aspect of the present invention, a method for providing a neural network that includes a network configuration that has been created using the above method is provided, the neural network being designed in particular for implementing functions of a technical system, in particular a robot, a vehicle, a tool, or a work machine.

According to a further aspect of the present invention, a use of a neural network that includes a network configuration that has been created using the above method for the predefined application is provided, the neural network being designed in particular for implementing functions of a technical system, in particular a robot, a vehicle, a tool, or a work machine.

According to a further aspect of the present invention, a device for ascertaining a suitable network configuration for a neural network for a predefined application, in particular for implementing functions of a technical system, in particular a robot, a vehicle, a tool, or a work machine, is provided, the application being determined in the form of training data; the network configuration indicating the architecture of the neural network. In accordance with an example embodiment of the present invention, the device is designed for carrying out the following steps:
a) starting from an instantaneous network configuration, by applying approximate network morphisms, multiple network configurations to be evaluated are generated which differ in a portion of the instantaneous network configuration;
b) ascertaining affected network portions of the network configurations;
c) multiphase training of each of the network configurations to be evaluated, under predetermined training conditions, in a first phase, in each case network parameters of a portion that is not changed by applying the particular approximate network morphism remaining unconsidered during the training, and all network parameters being trained in at least one further phase;
d) determining a prediction error for each of the network configurations; and
e) selecting the suitable network configuration as a function of the determined prediction errors.

According to a further aspect of the present invention, a control unit, in particular for controlling functions of a technical system, in particular a robot, a vehicle, a tool, or a work machine, that includes a neural network is provided, the control unit being configured with the aid of the example method.

### BRIEF DESCRIPTION OF THE DRAWINGS

Specific embodiments are explained in greater detail below with reference to the figures.

FIG. 1 shows the design of a conventional neural network.

FIG. 2 shows one possible configuration of a neural network that includes back-coupling and bypass layers.

FIG. 3 shows a flow chart for illustrating a method for ascertaining a network configuration of a neural network in accordance with an example embodiment of the present invention;

FIG. 4 shows a depiction of a method for improving a network configuration with the aid of a method for ascertaining a network configuration of a neural network in accordance with an example embodiment of the present invention.

FIG. 5 shows an illustration of one example for a resulting network configuration for a convolutional (folding) neural network.

### DETAILED DESCRIPTION OF EXAMPLE EMBODIMENTS

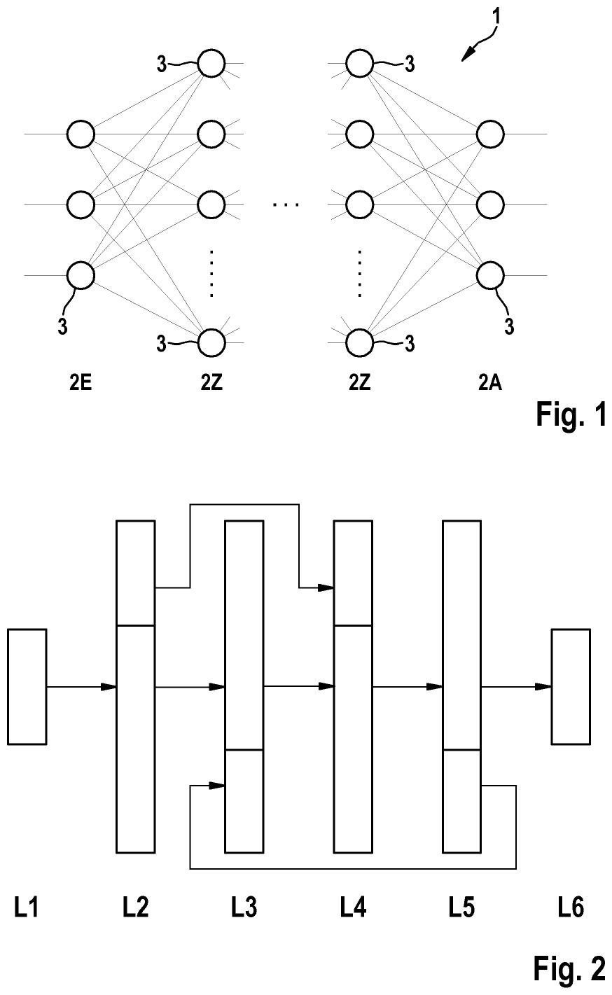

FIG. 1 shows the basic design of a neural network 1, which generally includes multiple cascaded neuron layers 2, each including multiple neurons 3. Neuron layers 2 include an input layer 2E for applying input data, multiple intermediate layers 2Z, and an output layer 2A for outputting computation results.

Neurons 3 of neuron layers 2 may correspond to a conventional neuron function

$${O}_{j} = ϕ ( {\sum }_{i = 1}^{M} ( {x}_{i} {w}_{i , j} ) - {θ}_{j} ) ,$$

where Oⱼ is the neuron output of the neuron, φ is the activation function, xᵢ is the particular input value of the neuron, w_{i,j} is a weighting parameter for the ith neuron input in the jth neuron layer, and θⱼ is an activation threshold. The weighting parameters, the activation threshold, and the selection of the activation function may be stored as neuron parameters in registers of the neuron.

The neuron outputs of a neuron 3 may each be passed on as neuron inputs to neurons 3 of the other neuron layers, i.e., one of the subsequent or one of the preceding neuron layers 2, or, if a neuron 3 of output layer 2A is involved, may be output as a computation result.

Neural networks 1 formed in this way may be implemented as software, or with the aid of computation hardware that maps a portion or all of the neural network as an electronic (integrated) circuit. Such computation hardware is then generally selected for building a neural network when the computation is to take place very quickly, which would not be achievable with a software implementation.

The structure of the software or hardware in question is predefined by the network configuration, which is determined by a plurality of configuration parameters. The network configuration determines the computation rules of the neural network. In a conventional network configuration as schematically shown in FIG. 1, for example, the configuration parameters include the number of neuron layers, the particular number of neurons in each neuron layer, the network parameters which are specified by the weightings, the activation threshold, and an activation function, information for coupling a neuron to input neurons and output neurons, and the like.

Apart from the network configuration described above, further configurations of neural networks are possible in which neurons are provided, which on the input side are coupled to neurons from various neuron layers, and which on the output side are coupled to neurons of various neuron layers. Furthermore, in this regard in particular neuron layers may also be provided which provide back-coupling, i.e., which on the input side are provided with neuron layers which on the input side are provided, with respect to the data flow on the output side of the neuron layer in question. In this regard, FIG. 2 schematically shows one possible configuration of a neural network that includes multiple layers L1 through L6 which are initially coupled to one another in a conventional manner, as schematically illustrated in FIG. 1; i.e., neuron inputs are linked to neuron outputs of the preceding neuron layer. In addition, neuron layer L3 includes an area which on the input side is coupled to neuron outputs of neuron layer L5. Neuron layer L4 may also be provided for being linked on the input side to outputs of neuron layer L2.

In the following discussion, an example method in accordance with the present invention for determining an optimized network configuration for a neural network, based on a predetermined application, is carried out. The application is determined essentially by the magnitude of input parameter vectors and their associated output parameter vectors, which represent the training data that define a desired network behavior or a certain task.

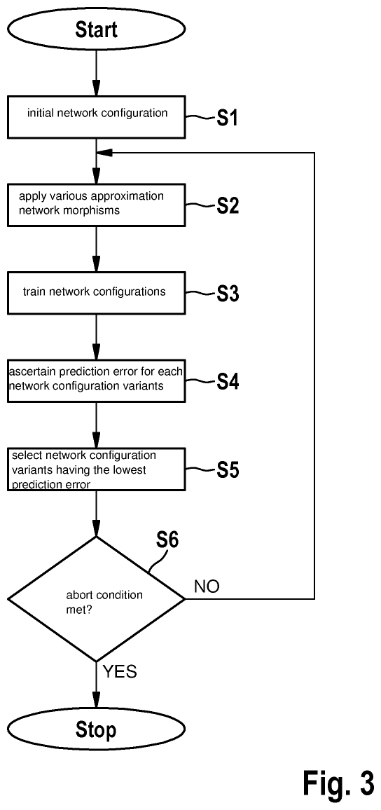

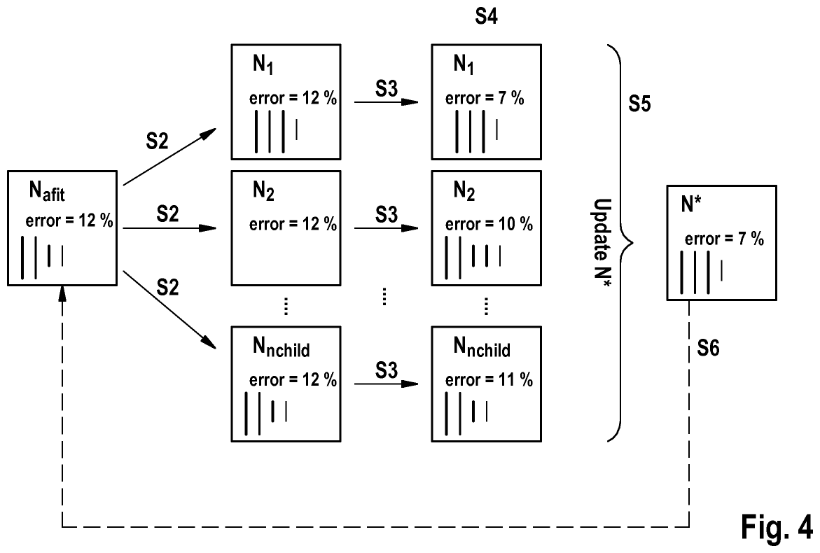

A method for ascertaining a network configuration of a neural network is described in greater detail in FIG. 3. FIG. 4 correspondingly shows the course of the iteration of the network configuration.

A starting network configuration for a neural network is initially assumed in step S1.

Based on the starting network configuration, variations of network configurations N_{1 . . . nchild} are determined as instantaneous network configuration Nₐₖₜ in step S2 by applying various approximate network morphisms.

The network morphisms generally correspond to predetermined rules that may be determined with the aid of an operator. A network morphism is generally an operator T that maps a neural network N onto a network TN, where the following applies:

N^{w}(x)=(TN)^{\tilde{w}}(x) for xεX,

where w are the network parameters (weightings) of neural network N, and \tilde{w} are the network parameters of varied neural network TN. X corresponds to the space to which the neural network is applied. Network morphisms are functions that manipulate a neural network in such a way that their prediction error for the instantaneous training state is identical to the unchanged neural network, but may include different performance parameters after a further training. n_{child} network configuration variants are obtained by the variation in step S2.

Approximate network morphisms are to be used here for which the specification that the initial network configuration and the modified configuration have the same prediction error after applying the approximate network morphism applies only to a limited extent. Approximate network morphisms are rules for changes to the existing network configuration, it being permissible for the resulting performance of the modified neural network to deviate from the performance of the underlying neural network by a certain extent. Approximate network morphisms may therefore include addition or deletion of individual neurons or neuron layers, as well as modifications of one or multiple neurons with respect to their input-side and output-side couplings to further neurons of the neural network, or with respect to the changes in the neuron behavior, in particular the selection of their activation functions. In particular, approximate network morphisms are intended to involve only changes of portions of the neural network while maintaining portions of the instantaneous network configuration.

The varied neural networks that are generated by applying the above approximate network morphisms T are to be trained for achieving a minimized prediction error that results on p(x), i.e., a distribution on X; i.e., network morphism T is an approximate network morphism if, for example, the following applies:

$${min}_{\tilde{w}} {E}_{p ( x )} ‖ {N}^{w} ( x ) - {( TN )}^{\tilde{w}} ( x ) ‖ < ɛ ,$$

where ϵ>0, for example is between 0.5% and 10%, preferably between 1% and 5%, and Eₚ₍ₓ₎ corresponds to a prediction error over distribution p(x).

In practice, the above equation is not evaluatable, since distribution p(x) is generally unknown and X is generally very large. Therefore, it is possible to modify the above criterion and use only provided training data Xₜᵣₐᵢₙ.

$${min}_{\tilde{w}} \frac{1}{\vert {X}_{train} \vert} {\sum }_{x ∈ {X}_{train}} ‖ {N}^{w} ( x ) - {( TN )}^{\tilde{w}} ( x ) ‖$$

The minimum of the above equation may be evaluated using the same method that is used for training the varied neural networks, for example stochastic gradient descent (SGB). This is training phase 1 in the above-described method, as described below:

The network configurations thus obtained are trained in step S3. For this purpose, during the training the network parameters of the varied network configurations are ascertained as follows. It is initially determined which of the neurons are affected by applying the approximate network morphism. Affected neurons correspond to those neurons that are connected to a variation in the network configuration on the input side or on the output side. Thus, for example, affected neurons are all those neurons
that were connected to a neuron, which is removed by the variation, on the input side and on the output side, and
that were connected to an added neuron on the input side or on the output side, and
that were connected to a modified neuron on the input side or on the output side.

By definition, the application of the approximate network morphism results in only a partial change in the network configuration in the network configurations ascertained in step S2. Portions of the neural network of the varied network configurations thus correspond to portions of the neural network of the underlying instantaneous network configuration.

The training now takes place in a first training phase for all generated network configuration variants, under predetermined first training conditions. During the training of the neural networks that are predefined by the network configuration variants, the unchanged, unaffected portions or neurons are not trained at the same time; i.e., the corresponding network parameters that are associated with the neurons of the unaffected portions of the neural network are accepted without changes and fixed for the further training. Thus, only the network parameters of the affected neurons are taken into account in the training method and correspondingly varied.

To obtain an identical evaluation standard for all network configuration variants, the training takes place for a predetermined number of training cycles, using a predetermined training algorithm. The predetermined training algorithm may, for example, provide an identical learning rate and an identical learning method, for example a back-propagation or cosine-annealing learning method.

In addition, for example, the predetermined training algorithm of the first training phase may include a predetermined first number of training passes, for example between 3 and 10, in particular 5.

The training now takes place for all generated network configuration variants in a second or further training phase, under predetermined second training conditions according to a conventional training method in which all network parameters are trained.

To obtain an identical evaluation standard for all network configuration variants, the training of the second training phase takes place under identical conditions, i.e., an identical training algorithm for a predetermined number of training cycles, an identical learning rate, and in particular with application of a back-propagation or cosine-annealing learning method according to the second training conditions. For example, the second training phase may include a second number of training passes, for example between 15 and 100, in particular 20.

With the aid of the formula

$${N}^{*} = arg {min}_{j = 1 , … , {n}_{child}} error ( {TN}_{j} ) ,$$

after the training, prediction error error(TNⱼ) is ascertained as a performance parameter for each of the network configuration variants in step S4, and the or those network configuration variants having the lowest prediction error is/are selected for a further optimization in step S5.

After checking an abortion criterion in step S6, the one or multiple network configuration variants are provided as instantaneous network configurations for a next computation cycle. If the abort condition is not met (alternative: no), the method is continued with step S2. Otherwise (alternative: yes), the method is aborted. The abort condition may include:
a predetermined number of iterations has been reached,
a predetermined prediction error value has been reached by at least one of the network configuration variants.

The method is likewise applicable to specialized neural networks, such as convolutional neural networks, which include computation layers of different layer configurations, in that after the application of the approximate network morphisms for ascertaining the network configuration variants, only those portions, in the present case, individual layers of the convolutional neural network, that have been changed by the corresponding approximate network morphism are trained. Layer configurations may include: a convolution layer, a normalization layer, an activation layer, and a max pooling layer. These layers, the same as neuron layers of conventional neural networks, may be coupled in a straightforward manner, and may contain back-coupling and/or skipping of individual layers. The layer parameters may include, for example, the layer size, a size of the filter kernel of a convolution layer, a normalization kernel for a normalization layer, an activation kernel for an activation layer, and the like.

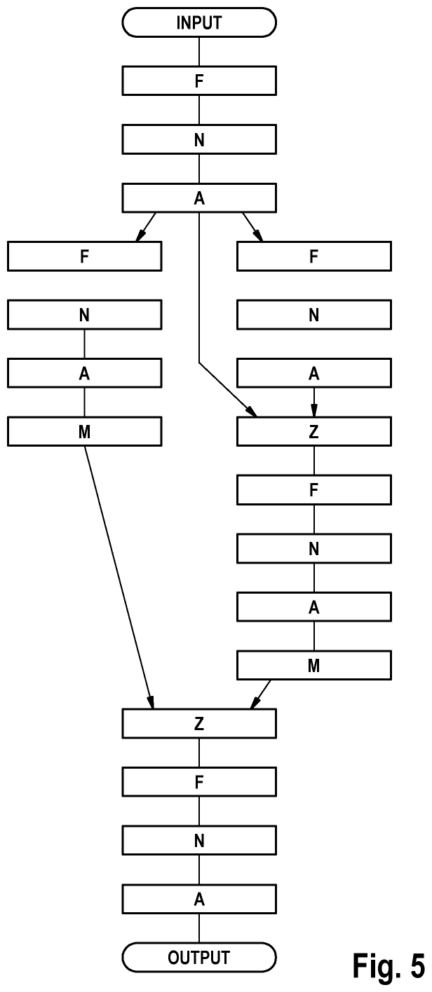

One example of a resulting network configuration is schematically illustrated in FIG. 5, including convolution layers F, normalization layers N, activation layers A, fusion layers Z for fusing outputs of various layers, and max pooling layers M. Options for combining the layers and variation options for such a network configuration are apparent.

The above example method allows the architecture search of network configurations to be speeded up in an improved manner, since the evaluation of the performance/prediction error of the variants of network configurations may be carried out significantly more quickly.

The network configurations thus ascertained may be used for selecting a suitable configuration of a neural network for a predefined task. The optimization of the network configuration is closely related to the task at hand. The task results from the specification of training data, so that prior to the actual training, initially the training data from which the optimized/suitable network configuration for the given task is ascertained must be defined. For example, image recognition and image classification methods may be defined by training data containing input images, object associations, and object classifications. In this way, network configurations may in principle be determined for all tasks defined by training data.

A neural network configured in this way may thus be used in a control unit of a technical system, in particular in a robot, a vehicle, a tool, or a work machine, in order to determine output variables as a function of input variables. The output variables may include, for example, a classification of the input variable (for example, an association of the input variable with a class of a predefinable plurality of classes), and in the case that the input data include image data, the output variables may include an in particular pixel-by-pixel semantic segmentation of these image data (for example, an area-by-area or pixel-by-pixel association of sections of the image data with a class of a predefinable plurality of classes). In particular, sensor data or variables ascertained as a function of sensor data are suitable as input variables of the neural network. The sensor data may originate from sensors of the technical system, or may be externally received from the technical system. The sensors may include in particular at least one video sensor and/or at least one radar sensor and/or at least one LIDAR sensor and/or at least one ultrasonic sensor. A processing unit of the control unit of the technical system may control at least one actuator of the technical system with a control signal as a function of the output variables of the neural network. For example, a movement of a robot or vehicle may thus be controlled, or a control of a drive unit or of a driver assistance system of a vehicle may take place.

1-15. (canceled)

16. A method for ascertaining a suitable network configuration for a neural network for a predefined application for implementing functions of a technical system, the technical system including a robot, or a vehicle, or a tool, or a work machine, the predefined application being determined in the form of training data, the network configuration indicating an architecture of the neural network, the method comprising the following steps:
a) starting from an instantaneous network configuration, generating multiple network configurations which differ from a portion of the instantaneous network configuration by applying approximate network morphisms;
b) ascertaining affected network portions of the network configurations;
c) multiphase training each of the multiple network configurations, under predetermined training conditions, in a first phase, in each case, network parameters of a portion that is not changed by applying the approximate network morphism remaining unconsidered during the training, and all network parameters being trained in at least one further phase;
d) determining a resulting prediction error for each of the multiple network configurations; and
e) selecting the suitable network configuration as a function of the determined resulting prediction errors.

17. The method as recited in claim 16, wherein steps a) through e) are carried out iteratively multiple times by using, in each case, the selected suitable network configuration as the instantaneous network configuration for generating multiple network configurations.

18. The method as recited in claim 17, wherein the method is ended when an abort condition is met, the abort condition involving an occurrence of at least one of the following events:
a predetermined number of iterations has been reached,
a predetermined prediction error value has been reached by at least one of the multiple network configurations.

19. The method as recited in claim 16, wherein each of the approximate network morphisms provide a change in a network configuration at an instantaneous training state in which the prediction error does not change by more than a predefined maximum error amount.

20. The method as recited in claim 16, wherein the approximate network morphisms in each case provide for removal, and/or addition, and/or modification of one or multiple neurons or one or multiple neuron layers.

21. The method as recited in claim 16, wherein the approximate network morphisms in each case provide for removal, and/or addition, and/or modification of one or multiple layers, the layers including one or multiple convolution layers, one or multiple normalization layers, one or multiple activation layers, and one or multiple fusion layers.

22. The method as recited in claim 20, wherein the training data are predefined by input parameter vectors and output parameter vectors associated with the input parameter vectors, the prediction error of each network configuration after the further training phase being determined as a measure that results from deviations between model values that result from a neural network, determined by the network configuration, based on the input parameter vectors, and from the output parameter vectors associated with the input parameter vectors.

23. The method as recited in claim 16, wherein: (i) shared predetermined first training conditions for training each of the network configurations in the first training phase specify a number of training passes and/or a training time and/or a training method, and/or (ii) shared predetermined second training conditions for training each of the network configurations in the second training phase specify a number of training passes and/or a training time and/or a training method.

24. The method as recited in claim 16, wherein affected network portions of the network configures are all those network portions: (i) that were connected to a network portion, which is removed by the approximate network morphisms, on an input side and on an output side, and (ii) that were connected to an added network portion on the input side or on the output side, and (iii) that were connected to a modified network portion on the input side or on the output side.

25. A method for implementing functions of a technical system, the technical system including a robot, or a vehicle, or a tool, or a work machine, the method comprising:
ascertaining a suitable network configuration for a neural network for a predefined application for implementing the functions of the robot, or the vehicle, or the tool, or the work machine, the predefined application being determined in the form of training data, the network configuration indicating an architecture of the neural network, the ascertaining of the suitable network including:
a) starting from an instantaneous network configuration, generating multiple network configurations which differ from a portion of the instantaneous network configuration by applying approximate network morphisms;
b) ascertaining affected network portions of the network configurations;
c) multiphase training each of the multiple network configurations, under predetermined training conditions, in a first phase, in each case, network parameters of a portion that is not changed by applying the approximate network morphism remaining unconsidered during the training, and all network parameters being trained in at least one further phase;
d) determining a resulting prediction error for each of the multiple network configurations; and
e) selecting the suitable network configuration as a function of the determined resulting prediction errors; and
implementing the functions of the robot, or the vehicle, or the tool, or the work machine using the neural network corresponding to the suitable network configuration.

26. A device for ascertaining a suitable network configuration for a neural network for a predefined application for implementing functions of a technical system, the technical system including a robot, or a vehicle, or a tool, or a work machine, the application being determined in the form of training data, the network configuration indicating an architecture of the neural network, the device being configured to:
a) starting from an instantaneous network configuration, generate multiple network configurations which differ from a portion of the instantaneous network configuration by applying approximate network morphisms;
b) ascertain affected network portions of the network configurations;
c) multiphase train each of the multiple network configurations, under predetermined training conditions, in a first phase, in each case, network parameters of a portion that is not changed by applying the particular approximate network morphism remaining unconsidered during the training, and all network parameters being trained in at least one further phase;
d) determine a resulting prediction error for each of the network configurations; and
e) select the suitable network configuration as a function of the determined prediction errors.

27. A control unit configured to control functions of a technical system, the technical system including a robot, or a vehicle, or a tool, or a work machine, the control unit including a neural network that is configured by:
ascertaining a suitable network configuration for the neural network for a predefined application for implementing the functions of the robot, or the vehicle, or the tool, or the work machine, the predefined application being determined in the form of training data, the network configuration indicating an architecture of the neural network, the ascertaining of the suitable network including:
a) starting from an instantaneous network configuration, generating multiple network configurations which differ from a portion of the instantaneous network configuration by applying approximate network morphisms;
b) ascertaining affected network portions of the network configurations;
c) multiphase training each of the multiple network configurations, under predetermined training conditions, in a first phase, in each case, network parameters of a portion that is not changed by applying the approximate network morphism remaining unconsidered during the training, and all network parameters being trained in at least one further phase;
d) determining a resulting prediction error for each of the multiple network configurations; and
e) selecting the suitable network configuration as a function of the determined resulting prediction errors.

28. A non-transitory electronic memory medium on which is stored a computer program for ascertaining a suitable network configuration for a neural network for a predefined application for implementing functions of a technical system, the technical system including a robot, or a vehicle, or a tool, or a work machine, the predefined application being determined in the form of training data, the network configuration indicating an architecture of the neural network, the computer program, when executed by a computer, causing the computer to perform the following steps:
a) starting from an instantaneous network configuration, generating multiple network configurations which differ from a portion of the instantaneous network configuration by applying approximate network morphisms;
b) ascertaining affected network portions of the network configurations;
c) multiphase training each of the multiple network configurations, under predetermined training conditions, in a first phase, in each case, network parameters of a portion that is not changed by applying the approximate network morphism remaining unconsidered during the training, and all network parameters being trained in at least one further phase;
d) determining a resulting prediction error for each of the multiple network configurations; and
e) selecting the suitable network configuration as a function of the determined resulting prediction errors.
